(19) United States
(12) Patent Application Publication
(10) Pub. No.: US 2026/0301761 A1
(43) Pub. Date: Oct. 1, 2026

(54) METHOD, APPARATUS, DEVICE, STORAGE MEDIUM AND PROGRAM PRODUCT FOR DETERMINING SAME AUDIO

(71) Applicant: Beijing Zitiao Network Technology Co., Ltd., Beijing (CN)

(72) Inventors: Xia LIANG, Beijing (CN); Wenyu YANG, Beijing (CN); Binghua QIAN, Beijing (CN); Bilei ZHU, Beijing (CN)

(21) Appl. No.: 19/416,611

(22) Filed: Dec. 11, 2025

(30) Foreign Application Priority Data
Mar. 31, 2025 (CN) 202510393623.8

(51) Int. Cl. G10L 25/51

(52) U.S. Cl. CPC G10L 25/51

(57) ABSTRACT

The present application discloses a method for determining a same audio, an apparatus, a device, a storage medium, and a program product thereof. The method comprises: acquiring a first target audio and a second target audio to be compared; performing slicing processing on the first target audio and the second target audio to obtain a plurality of first audio segments corresponding to the first target audio and a plurality of second audio segments corresponding to the second target audio; generating a first audio fingerprint corresponding to each first audio segment based on audio features of the first audio segment, and generating a second audio fingerprint corresponding to each second audio segment based on audio features of the second audio segment; and determining audio similarity between the first target audio and the second target audio in different audio segments according to the first audio fingerprint and the second audio fingerprint.

### CROSS-REFERENCE TO RELATED APPLICATIONS

The present application claims the benefit of priority to the Chinese patent application No. 202510393623.8 filed with Chinese Patent Office on Mar. 31, 2025, which is hereby incorporated by reference in its entirety into the present application.

### TECHNICAL FIELD

The present disclosure relates to the technical field of audio processing, and in particular, to a method for determining a same audio, an apparatus, a device, a storage medium, and a program product thereof.

### BACKGROUND

At present, discrimination of same audios is mainly implemented based on algorithm models. However, when calculating audio similarity, it is difficult for these algorithm models output confident judgment results for audios such as medleys, repeated melodies and white noise, and discrimination errors easily occur, resulting in relatively low discrimination accuracy and relatively high mismatch of same audios.

### SUMMARY

In view of this, the present disclosure provides a method for determining a same audio, an apparatus, a device, a storage medium, and a program product thereof to solve the problem of relatively low discrimination accuracy and relatively high mismatch of same audios.

In a first aspect, the present disclosure provides a method for determining a same audio, comprising: acquiring a first target audio and a second target audio to be compared; performing slicing processing on the first target audio and the second target audio to obtain a plurality of first audio segments corresponding to the first target audio and a plurality of second audio segments corresponding to the second target audio; generating a first audio fingerprint corresponding to each first audio segment based on an audio feature of the first audio segment, and generating a second audio fingerprint corresponding to each second audio segment based on an audio feature of the second audio segment; and determining audio similarity between the first target audio and the second target audio in different audio segments according to the first audio fingerprint and the second audio fingerprint.

In a second aspect, the present disclosure provides an apparatus for determining a same audio, comprising: an acquiring module, configured to acquire a first target audio and a second target audio to be compared; a slicing module, configured to perform slicing processing on the first target audio and the second target audio to obtain a plurality of first audio segments corresponding to the first target audio and a plurality of second audio segments corresponding to the second target audio; a fingerprint generating module, configured to generate a first audio fingerprint corresponding to each first audio segment based on an audio feature of the first audio segment, and generate a second audio fingerprint corresponding to each second audio segment based on an audio feature of the second audio segment; and a similarity determining module, configured to determine audio similarity between the first target audio and the second target audio in different audio segments according to the first audio fingerprint and the second audio fingerprint.

In a third aspect, the present disclosure provides a computer device, comprising: a memory and a processor, where the memory and the processor are communicatively connected to each other, the memory stores computer instructions, and the processor executes the computer instructions to perform the method for determining a same audio according to the first aspect or any implementation corresponding thereto.

In a fourth aspect, the present disclosure provides a computer-readable storage medium, where the computer-readable storage medium stores computer instructions, and the computer instructions are configured to cause a computer to perform the method for determining a same audio according to the first aspect or any implementation corresponding thereto.

In a fifth aspect, the present disclosure provides a computer program product, comprising computer instructions, where the computer instructions are configured to cause a computer to perform the method for determining a same audio according to the first aspect or any implementation corresponding thereto.

According to the method for determining a same audio, the apparatus, the device, the storage medium, and the program product thereof provided by the present disclosure, before determining audio similarity, the first target audio and the second target audio to be compared are sliced to obtain corresponding audio segments; at the same time, the audio fingerprint corresponding to each audio segment is generated, and the audio segments are compared based on the audio fingerprint of each audio segments, so as to determine the audio similarity between the first target audio and the second target audio in different audio segments.

### BRIEF DESCRIPTION OF THE DRAWINGS

In order to more clearly illustrate the technical solutions in the specific embodiments of the present disclosure or in the related art, drawings that need to be used in description of the specific embodiments or the related art will be briefly introduced below. It is obvious that the drawings in the following description are some embodiments of the present disclosure, and for those of ordinary skill in the art, other drawings may also be acquired according to these drawings without paying any creative effort.

FIG. 1 is a schematic flowchart of a method for determining a same audio according to an embodiment of the present disclosure;

FIG. 2 is a schematic flowchart of another method for determining a same audio according to an embodiment of the present disclosure;

FIG. 3 is a schematic flowchart of another method for determining a same audio according to an embodiment of the present disclosure;

FIG. 4 is a block diagram of an apparatus for determining a same audio according to an embodiment of the present disclosure; and

FIG. 5 is a schematic diagram of a hardware structure of a computer device according to an embodiment of the present disclosure.

### DETAILED DESCRIPTION OF EMBODIMENTS

In order to make the objectives, technical solutions, and advantages of the embodiments of the present disclosure clearer, the technical solutions in the embodiments of the present disclosure will be described clearly and comprehensively with reference to the drawings in the embodiments of the present disclosure. It is clear that the described embodiments are part of the embodiments of the present disclosure, rather than all of them. All other embodiments obtained by those skilled in the art based on the embodiments of the present disclosure without paying any creative effort shall fall within the protection scope of the present disclosure.

It may be understood that before using the technical solutions disclosed in the embodiments of the present disclosure, users shall be informed of the type, range of use, use scenarios, etc., of personal information involved in the present disclosure and obtain the authorization of the users in an appropriate manner in accordance with relevant laws and regulations.

For example, in response to receiving an active request from a user, prompt information is sent to the user to clearly inform the user that the requested operation will need to access and use the personal information of the user. In this way, the user may independently choose whether to provide the personal information to software or hardware, such as an electronic device, an application, a server, or a storage medium, that performs the operations of the technical solutions of the present disclosure based on the prompt information.

As an optional but non-limiting implementation, in response to receiving the active request from the user, the prompt information may be sent to the user in the form of, for example, a pop-up window, and the prompt information may be presented in the pop-up window in text. In addition, the pop-up window may also include a selection control for the user to choose whether to “agree” or “disagree” to provide the personal information to the electronic device.

It may be understood that the above process of notifying and acquiring user authorization is only illustrative and does not constitute a limitation on the implementations of the present disclosure, and other manners that satisfy the relevant laws and regulations may also be applied to the implementations of the present disclosure.

It may be understood that the data involved in the technical solution (including but not limited to the data itself, acquisition or use of the data) shall comply with the requirements of corresponding laws, regulations, and related provisions.

The discrimination of same audios is mainly implemented based on algorithm models. However, these algorithm models are prone to errors in discrimination of same audios. This is mainly because these algorithm models cannot output confident judgment results for audios such as medleys, repeated melodies, and white noise when determining audio similarity. Aggregation of same song groups based on this capability also easily leads to transitivity problems within a song group (for example, a medley successfully enters a group, resulting in multiple different songs appearing in the song group), resulting in relatively low discrimination accuracy and relatively high mismatch of same audios.

Based on this, in the technical solution of the present disclosure, before determining audio similarity, an audio is sliced and then same audio segments are effectively identified based on an audio fingerprint, thereby facilitating accurate recall for audios such as medleys, repeated melodies, and white noise, improving discrimination accuracy of the same audio segments, and reducing mismatch of the same audio segments.

According to an embodiment of the present disclosure, an embodiment of a method for determining a same audio is provided. It should be noted that the steps shown in the flowchart of the drawings may be executed in a computer system, such as a set of computer executable instructions, and although a logical order is shown in the flowchart, in some cases, the steps shown or described may be executed in an order different from that here.

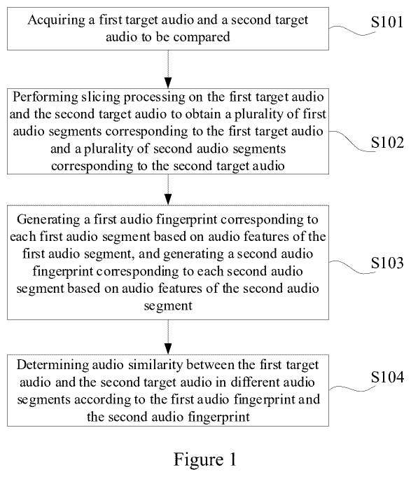

In this embodiment, a method for determining a same audio is provided, which may be used for computer devices, such as computers, tablets, etc. FIG. 1 is a flowchart of a method for determining a same audio according to an embodiment of the present disclosure. As shown in FIG. 1, the process includes the following steps.

Step S101: acquiring a first target audio and a second target audio to be compared.

The first target audio and the second target audio are an audio pair that needs to be compared for similarity, where the first target audio and the second target audio may be completely same, partially same, or completely different.

Specifically, the first target audio and the second target audio may be acquired from an existing audio group, read from a local storage device, downloaded from a public website through a search engine, or acquired through other means. The manner of acquiring the first target audio and the second target audio is not specifically limited here.

Step S102: performing slicing processing on the first target audio and the second target audio to obtain a plurality of first audio segments corresponding to the first target audio and a plurality of second audio segments corresponding to the second target audio.

The audio duration of the first target audio is parsed, and audio slicing parameters, comprising a segment frame number (patch size) and a segment step size (hop size) for audio segmentation, are set for the first target audio. For example, the segment frame number (patch size) may be set to 100 frames, and the segment step size (hop size) may be set to 50 frames. Then, an audio segment with a length of patch size is extracted every hop size from the start point of the first target audio, and the above process is repeated until the first target audio is completely sliced to obtain a plurality of corresponding first audio segments.

Similarly, an audio segment with the length of patch size is extracted every hop size from the start point of the second target audio, and the process is repeated until the second target audio is completely sliced, so as to obtain a plurality of corresponding second audio segments.

Then, each of the first audio segments and each of the second audio segments are saved as separate audio files, and a corresponding identification is added to each audio segment to facilitate quick identification of each audio segment.

Step S103: generating a first audio fingerprint corresponding to each first audio segment based on audio features of the first audio segment, and generating a second audio fingerprint corresponding to each second audio segment based on audio features of the second audio segment.

The audio features are used to represent the features of the audio segment, including a time-frequency feature of the audio segment, a fundamental frequency of the audio, a zero-crossing rate of an audio signal, spectral flatness of the audio signal, etc. The audio fingerprint is a unique identifier representing the audio segment. For each first audio segment, an audio signal spectrum corresponding thereto is parsed, the corresponding audio features are extracted therefrom, and the audio features are fused by a preset fingerprint generation method (such as a hash function, a histogram, principal component analysis, etc.) to obtain the first audio fingerprint capable of representing the uniqueness of each first audio segment.

In a specific example, taking the hash function as an example, for the audio features extracted from the first audio segment, the hash function is used to calculate a peak value of a feature vector of the audio features, the audio features are processed according to a fingerprint feature parameter “max peak=3”, the largest three peak values are selected, other peak values are discarded, and the selected peak values are used to construct a hash fingerprint feature to form a corresponding first audio fingerprint.

Similarly, the method of generating the second audio fingerprint according to the audio features of the second audio segment is the same as the above method of generating the first audio fingerprint, which will not be repeated here.

Step S104: determining audio similarity between the first target audio and the second target audio in different audio segments according to the first audio fingerprint and the second audio fingerprint.

Each of the first audio fingerprints corresponding to the first target audio is subjected to feature comparison with each of the second audio fingerprints corresponding to the second target audio to determine similar audio fingerprint pairs. The audio similarity between the similar audio fingerprint pairs is calculated based on the duration of the audio segment, and by analogy, the audio similarity between the first target audio and the second target audio in different audio segments may be obtained, so that the same audio segments in the first target audio and the second target audio may be recalled according to the audio similarity.

According to the method for determining a same audio provided in this embodiment, before determining the audio similarity, the first target audio and the second target audio to be compared are sliced to obtain corresponding audio segments; at the same time, the audio fingerprint corresponding to each audio segment is generated, and the audio segments are compared based on the audio fingerprint of each audio segment, so as to determine the audio similarity between the first target audio and the second target audio in different audio segments, thereby effectively identifying the same audio segments in the first target audio and the second target audio, facilitating accurate recall for audios such as medleys, repeated melodies, and white noise, improving the discrimination accuracy of the same audio segment, reducing the mismatch of the same audio segment, and thus improving the robustness to locally different audios.

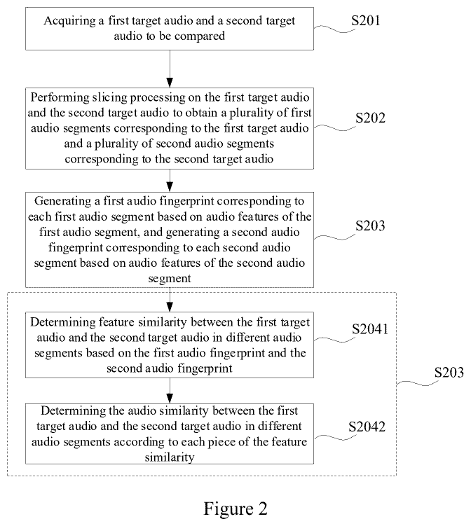

In this embodiment, a method for determining a same audio is provided, which may be used for computer devices, such as computers, tablets, etc. FIG. 2 is a flowchart of a method for determining a same audio according to an embodiment of the present disclosure. As shown in FIG. 2, the process includes the following steps.

Step S201: acquiring a first target audio and a second target audio to be compared. For details, please refer to the relevant description of the corresponding step in the embodiment shown above, which will not be repeated here.

Step S202: performing slicing processing on the first target audio and the second target audio to obtain a plurality of first audio segments corresponding to the first target audio and a plurality of second audio segments corresponding to the second target audio. For details, please refer to the relevant description of the corresponding step in the embodiment shown above, which will not be repeated here.

Step S203: generating a first audio fingerprint corresponding to each first audio segment based on the audio features of the first audio segment, and generating a second audio fingerprint corresponding to each second audio segment based on the audio features of the second audio segment. For details, please refer to the relevant description of the corresponding step in the embodiment shown above, which will not be repeated here.

Step S204: determining audio similarity between the first target audio and the second target audio in different audio segments according to the first audio fingerprint and the second audio fingerprint.

Specifically, Step S204 includes the following steps.

Step S2041: determining feature similarity between the first target audio and the second target audio in different audio segments based on the first audio fingerprint and the second audio fingerprint.

The feature similarity represents a feature similarity confidence level in different audio segments. As described above, the first audio fingerprint and the second audio fingerprint are generated based on the audio features of the corresponding audio segment, that is, the first audio fingerprint carries the audio features of the first audio segment, and the second audio fingerprint carries the audio features of the second audio segment. The first audio fingerprint and the second audio fingerprint are subjected to audio feature comparison at the start time of the corresponding audio segment to determine similar audio features, and the feature similarity between the two audio segments to be compared is determined based on the number of hits of the similar audio features and the length of the audio segment. By analogy, the feature similarity between the first target audio and the second target audio in different audio segments may be obtained.

In some optional implementations, Step S2041 includes the following steps.

Step a1: acquiring a duration corresponding to each audio segment.

Step a2: determining the number of feature hits at the start time of different audio segments to be compared based on the first audio fingerprint and the second audio fingerprint.

Step a3: determining the feature similarity between the different audio segments according to the number of feature hits and the duration.

The duration is the audio length of the audio segment. According to the duration of each audio segment, the start time and end time of each audio segment may be determined. For two different audio segments currently to be compared, the number of feature hits from the start time is counted according to the corresponding first audio fingerprint and the corresponding second audio fingerprint, and linear fitting is performed on the number of feature hits to obtain a corresponding linear fitting histogram. By analogy, a linear fitting histogram of comparison between each of the first audio segments and each of the second audio segments may be obtained.

By parsing the linear fitting histogram, for any first audio segment or second audio segment, a plurality of similar candidate audio segments similar thereto may be determined. According to the number of feature hits between the first audio segment and the similar candidate audio segments thereof, a feature similarity confidence level may be determined, that is, the greater the number of feature hits, the higher the feature similarity confidence level. The feature similarity confidence level is converted into the feature similarity based on a ratio of the duration of the audio segment to the number of feature hits.

In the above implementation, the number of feature hits at the start time of the different audio segments is counted, the feature confidence level between the different audio segments is determined using the number of feature hits, whether the different audio segments are similar is determined according to the feature confidence level, and the feature confidence level is converted into the feature similarity based on the duration of the audio segment, thereby improving the accurate calculation of the feature similarity of the audio segments.

Step S2042: determining the audio similarity between the first target audio and the second target audio in different audio segments according to each piece of the feature similarity.

According to the feature similarity between the first target audio and the second target audio in different audio segments, a matrix of the obtained feature similarity may be constructed. For example, the first target audio has M audio segments, and the second target audio has N audio segments, and the M audio segments are compared with the N audio segments in sequence, an M×N feature similarity matrix may be obtained. Data statistical analysis is performed on each piece of feature similarity in the feature similarity matrix, and the audio similarity between different audio segments is determined based on a data statistical analysis result.

In some optional implementations, Step S2042 includes the following steps.

Step b1: comparing pieces of the feature similarity between different audio segments, and determining the maximum feature similarity between the different audio segments.

Step b2: averaging the pieces of the maximum feature similarity to obtain target feature similarity between the different audio segments.

Step b3: determining the audio similarity between the different audio segments based on a difference between the target feature similarity and 1.

For each piece of feature similarity in the feature similarity matrix, the pieces of feature similarity are compared in units of rows, and the maximum feature similarity is selected therefrom, so that a plurality of pieces of maximum feature similarity may be obtained. Then, mean calculation is performed on the plurality of pieces of maximum feature similarity to obtain average similarity (that is, the target feature similarity), and then a difference between the target feature similarity and 1 is calculated, and the difference is taken as the audio similarity between the audio segments. The closer the difference is to 1, the higher the audio similarity, and the closer the difference is to 0, the lower the audio similarity.

In a specific example, a specific calculation method of the audio similarity is as follows:

$${S}_{matrix} = FingerPrint ( σ ( {\{ {hash}_{k} , {duration}_{k} \}}_{k = 1}^{K} ) ) \\ {PairDistance}_{k} = 1 - MaxMean ( {X}_{k} , {S}_{matrix k} )$$

where Sₘₐₜᵣᵢₓ represents a fingerprint matrix of the audio segments; k represents each audio segment; hashₖ represents the audio feature of each audio segment; durationₖ represents the duration of each audio segment; σ( ) represents a conversion function for combining the audio feature and the duration; FingerPrint( ) represents a fingerprint generation function, which outputs a matrix that may represent the feature of the audio segment; Xₖ represents a feature vector of any first audio segment; S_{matrix k} represents an audio fingerprint matrix corresponding to the second audio segment; MaxMean( ) represents a maximum average function; and PairDistanceₖ represents the audio similarity between two audio segments.

The target feature similarity between different audio segments is determined by using the maximum-average operation, and dissimilar local abnormal points may be found through the target feature similarity, so that the local abnormal points may be reflected in the final audio similarity, which is beneficial to improving the accuracy of the audio similarity, thereby accurately recalling the same audio segments according to the audio similarity.

According to the method for determining a same audio provided in this embodiment, the feature similarity between different audio segments is determined by the audio fingerprint corresponding to each audio segment, so that the similarity between different audio segments in terms of audio features may be accurately analyzed, and the audio similarity between different audio segments may be calculated according to the feature similarity in the subsequent step, thereby accurately analyzing the same features between the audio segments, accurately identifying the same audio segment in the first target audio and the second target audio, and improving the accurate identification of the same audio segment.

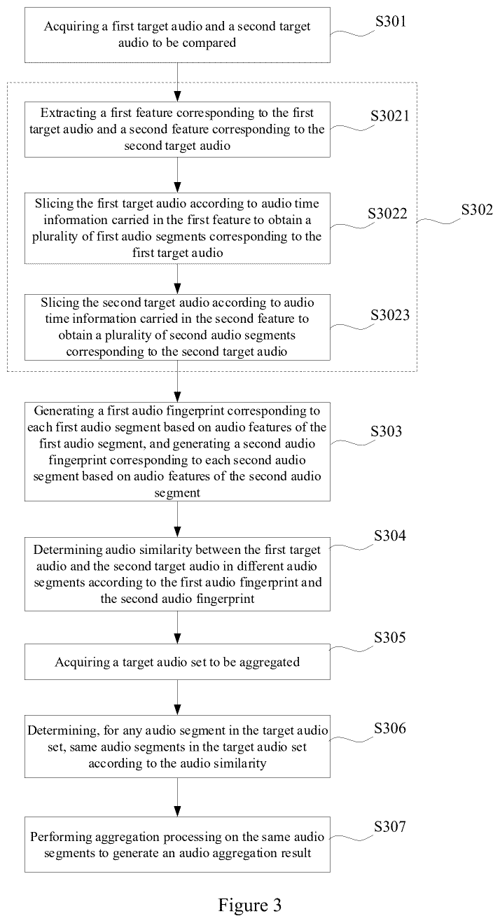

In this embodiment, a method for determining a same audio is provided, which may be used for computer devices, such as computers, tablets, etc. FIG. 3 is a flowchart of a method for determining a same audio according to an embodiment of the present disclosure. As shown in FIG. 3, the process includes the following steps.

Step S301: acquiring a first target audio and a second target audio to be compared. For details, please refer to the relevant description of the corresponding step in the embodiment shown above, which will not be repeated here.

Step S302: performing slicing processing on the first target audio and the second target audio to obtain a plurality of first audio segments corresponding to the first target audio and a plurality of second audio segments corresponding to the second target audio.

Specifically, Step S302 includes the following steps.

Step S3021: extracting a first feature corresponding to the first target audio and a second feature corresponding to the second target audio.

The first feature is used to represent a key attribute feature of the first target audio, such as a time-domain feature and a frequency-domain feature of an audio signal of the first target audio, an amplitude and a duration of the audio signal, etc. The second feature is used to represent a key attribute feature of the second target audio, such as a time-domain feature and a frequency-domain feature of an audio signal of the second target audio, the amplitude and the duration of the audio signal, etc.

The first target audio is preprocessed to remove noise signals in the first target audio to generate a preprocessed audio signal. Signal parsing is performed on the preprocessed audio signal, a plurality of pieces of feature data capable of representing the audio signal are extracted therefrom, and the plurality of pieces of feature data are fused to obtain the corresponding first feature. Similarly, the corresponding second feature may be extracted from the second target audio.

In some optional implementations, extracting the first feature corresponding to the first target audio includes the following steps.

Step c1: acquiring a frequency spectrum corresponding to the first target audio, and extracting peak point features from the frequency spectrum.

Step c2: combining the peak point features in a target region to generate a constellation feature corresponding to the target audio.

Step c3: performing encoding processing on the constellation feature to obtain the first feature.

The audio attribute of the first target audio is parsed, time-domain audio information of the first target audio and a sampling rate matching the first target audio are determined, the frequency range of the first target audio is determined according to the sampling rate, the audio signal in the time domain is converted into the frequency domain by fast Fourier transform, the frequency spectrum between frequency and amplitude is generated, and the energy distribution of the audio signal at different frequencies is represented by the frequency spectrum.

The target region is a region of interest in the first target audio, and the target region may be obtained by prior knowledge or automatic detection by a detection algorithm. A threshold method, derivative calculation or a peak detection algorithm is used to perform peak point detection on the frequency spectrum, the peak points of the frequency spectrum are extracted, and the peak point features are determined. Then, in the target region, the amplitude and phase corresponding to each peak point feature are converted to obtain the constellation point feature corresponding to each peak point feature, and the constellation feature is formed by each of the constellation point features. The constellation feature is encoded by a preset encoding method (such as hash encoding), and the audio time information of the first target audio is combined in the encoding process to obtain the corresponding encoded feature value, which is the first feature.

Similarly, the extraction of the second feature may be implemented in the above method.

In the above implementation, the peak point features are extracted, the constellation feature is generated according to the peak point features, and the constellation feature is encoded to obtain the corresponding first feature. In this way, feature encoding of the first target audio is realized, which facilitates fast comparison and similarity search of audio based on the first feature generated by encoding.

Step S3022: slicing the first target audio according to audio time information carried in the first feature to obtain a plurality of first audio segments corresponding to the first target audio.

The first feature generated above carries audio time information of the first target audio, and the audio length of the first target audio is represented by the audio time information, so that the start time and end time of the first target audio may be determined. Then, according to the audio slicing parameters, slicing processing is performed from the start time point of the first target audio until the end point of the first target audio is reached, to obtain a plurality of first audio segments.

Step S3023: slicing the second target audio according to audio time information carried in the second feature to obtain a plurality of second audio segments corresponding to the second target audio.

Similarly, the second target audio may be sliced according to the method described in Step S3022 to obtain a plurality of second audio segments corresponding to the second target audio, which will not be repeated here.

Step S303: generating a first audio fingerprint corresponding to each first audio segment based on audio features of the first audio segment, and generating a second audio fingerprint corresponding to each second audio segment based on audio features of the second audio segment. For details, please refer to the relevant description of the corresponding step in the embodiment shown above, which will not be repeated here.

Step S304: determining audio similarity between the first target audio and the second target audio in different audio segments according to the first audio fingerprint and the second audio fingerprint. For details, please refer to the relevant description of the corresponding step in the embodiment shown above, which will not be repeated here.

Step S305: acquiring a target audio set to be aggregated.

The target audio set is an audio set containing a plurality of audio segments, and the plurality of audio segments may be different expression forms of the same audio or different audios. The target audio set may be a combination of existing audio segments, may be read from a local storage device according to an aggregation requirement, or may be acquired from a public channel according to an aggregation requirement, which is not specifically limited here.

Step S306: determining, for any audio segment in the target audio set, a same audio segment in the target audio set according to the audio similarity.

For any audio segment in the target audio set, similarity comparison is performed between the audio segment and other audio segments in sequence, and the audio similarity between the audio segment and the other audio segments is determined in sequence according to the method of determining the audio similarity described above, so that one or more same audio segments corresponding to the audio segment may be determined from the other audio segments according to the audio similarity. Therefore, all same audio segments in the target audio set may be selected through the audio similarity.

Step S307: performing aggregation processing on the same audio segments to generate an audio aggregation result.

All same audio segments are aggregated according to corresponding audio information, such as aggregation in the time domain, aggregation in the frequency domain, aggregation in time-frequency representation, aggregation in frames, etc., to generate the corresponding audio aggregation result, thereby realizing effective aggregation of the same audio segments.

According to the method for determining a same audio provided in this embodiment, the target audio is sliced according to the audio time information to obtain the corresponding audio segments, which facilitates similarity comparison of audios at the level of audio segments, so as to recall the same audio segment quickly and accurately. Facing the target audio set to be aggregated, all same audio segments in the target audio set are selected according to the audio similarity, so as to effectively aggregate all same audio segments, avoid internal transitivity problems during aggregation of the same audio segments, ensure that no different audio appears in the aggregation of the same audio segments, and improve the audio aggregation effect.

The above method for determining a same audio is used to perform a precision and recall test of the same audio segment on three test sets, and specific test results are as follows.

The test set 1 is: top 100 Chinese songs with high popularity and online same song groups.

| | | Indicator |
|---|---|---|
| | | (high precision, |
| | | taking the |
| | | maximum |
| | | accuracy |
| | Scheme | as much as |
| Scheme name | overview | possible) |
| Precision and | Data in the test | 0.789/1 |
| recall in the table | set | |
| Deep scheme 1- | Online deep | 0.947/0.924 |
| dedup | scheme 1 | |
| Deep scheme 2- | Online deep | 0.838/0.927 |
| pairsim | scheme 2 | |
| Deep scheme 3- | Offline deep | 0.949/0.857 |
| pitchshift | scheme | |
| The present | Scheme | 0.983/0.91 |
| disclosure | based on | |
| | fingerprint | |
| | feature | |
| | optimization | |

The test set 2 is: evaluation of song groups with the same origin/similar song groups and comparable same results.

| | | Indicator (high | | |
|---|---|---|---|---|
| | | precision, | | |
| | | taking the | | Indicator (high |
| | | maximum | | recall, taking |
| | | accuracy as | | the maximum |
| | | much as | Indicator | recall as much |
| Scheme name | Scheme overview | possible) | (balance) | as possible) |
| Precision and | Ceiling data in the | 0.923/1 | | |
| recall in the table | test set | | | |
| Deep scheme 1- | Online deep scheme | 0.985/0.77 | 0.98/0.80 | 0.93/0.87 |
| dedup | 1 | | | |
| Deep scheme 2- | Online deep scheme | 0.942/0.86 | — | 0.93/0.87 |
| pairsim | 2 | | | |
| Deep scheme 3- | Offline deep scheme | 0.993/ | 0.981/ | 0.957/ |
| pitchshift | | 0.819 | 0.86 | 0.86 |
| The present | Scheme based on | 0.997/ | 0.99/ | 0.952/ |
| disclosure | fingerprint feature | 0.942 | 0.95 | 0.986 |
| | optimization | | | |

The test set 3 is: evaluation of song groups with the same origin/similar song groups and already-made same results.

| | | Indicator (high | | |
|---|---|---|---|---|
| | | precision, | | |
| | | taking the | | Indicator (high |
| | | maximum | | recall, taking |
| | | accuracy as | | the maximum |
| | | much as | Indicator | recall as much |
| Scheme name | Scheme overview | possible) | (balance) | as possible) |
| Precision and | Ceiling data in the | 0.351/1 | | |
| recall in the table | test set | | | |
| Deep scheme 1- | Online deep scheme | 0.95/ | 0.929/ | 0.82/ |
| dedup | 1 | 0.837 | 0.92 | 0.99 |
| Deep scheme 2- | Online deep scheme | 0.349/ | — | 0.343/ |
| pairsim | 2 | 0.993 | | 1.0 |
| Deep scheme 3- | Offline deep scheme | 0.945/ | 0.892/ | 0.758/ |
| pitchshift | | 0.735 | 0.77 | 0.7775 |
| The present | Scheme based on | 0.97/ | 0.955/ | 0.89/ |
| disclosure | fingerprint feature | 0.93 | 0.952 | 0.99 |
| | optimization | | | |

The clustering result is represented as follows:

| | Distance | | | | | |
|---|---|---|---|---|---|---|
| | threshold/ | | | | | |
| | corresponding | | | | | Number |
| | pairwise | Position | Recall | | | of |
| | accuracy | of | of | | Accuracy | recalled |
| | of the present | Result | 12 k | Accuracy | (song | seed |
| | disclosure | 1 | samples | (song) | group) | songs |
| Online | — | — | — | 0.568 | 0.784 | 539 |
| baseline | | | | | | |
| Origin 1.1 | — | — | — | 0.923 | 0.729 | 472 |
| Existing best | — | — | — | 0.950 | 0.926 | 285 |
| practice | | | | | | |
| Present | 0.156/(0.99) | Column | 0.586 | 0.994 | 0.964 | 343 |
| disclosure- | | J | | | | |
| high precision | | | | | | |
| Present | 0.16/(0.98) | Column | 0.600 | 0.986 | 0.949 | 363 |
| disclosure- | | K | | | | |
| accuracy | | | | | | |
| Present | 0.17/(0.96) | Column | 0.622 | 0.965 | 0.87 | 387 |
| disclosure- | | L | | | | |
| recall | | | | | | |
| Present | 0.18/(0.90+) | Column | 0.630 | 0.954 | 0.828 | 411 |
| disclosure- | | M | | | | |
| high recall | | | | | | |

It may be seen that the precision and recall of the present disclosure may reach 97%+ or 90%+, and the comprehensive effect of precision and recall exceeds the recall schemes in the related art. Specifically, a hierarchical clustering algorithm is implemented based on the method for determining a same audio of the present disclosure, and the clustering result includes four versions: high precision/accuracy/recall/high recall, the best effect may reach an accuracy of 99%, and the comprehensive effect exceeds the current best method.

An apparatus for determining a same audio is further provided in this embodiment. The apparatus is configured to implement the above embodiments and preferred implementations, which will not be repeated here. As used below, the term “module” may implement a combination of software and/or hardware for a predetermined function. Although the apparatus described in the following embodiments is preferably implemented in software, implementation in hardware, or a combination of software and hardware is also possible and contemplated.

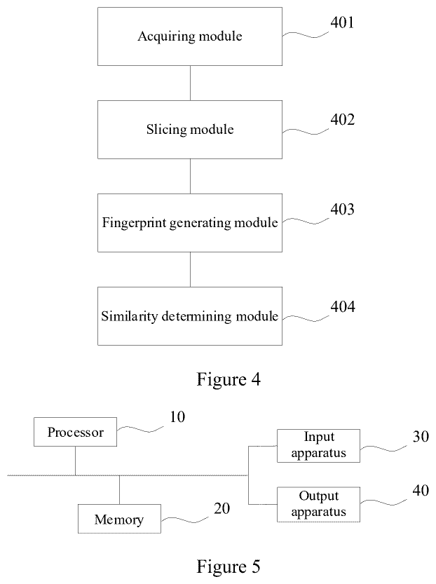

This embodiment provides an apparatus for determining a same audio, as shown in FIG. 4, comprising:
an acquiring module 401, configured to acquire a first target audio and a second target audio to be compared;
a slicing module 402, configured to perform slicing processing on the first target audio and the second target audio to obtain a plurality of first audio segments corresponding to the first target audio and a plurality of second audio segments corresponding to the second target audio;
a fingerprint generating module 403, configured to generate a first audio fingerprint corresponding to each first audio segment based on the audio features of the first audio segment, and generate a second audio fingerprint corresponding to each second audio segment based on the audio features of the second audio segment; and
a similarity determining module 404, configured to determine audio similarity between the first target audio and the second target audio in different audio segments according to the first audio fingerprint and the second audio fingerprint.

In some optional implementations, the similarity determining module 404 includes:
a feature similarity determining unit, configured to determine feature similarity between the first target audio and the second target audio in different audio segments based on the first audio fingerprint and the second audio fingerprint; and
an audio similarity determining unit, configured to determine the audio similarity between the first target audio and the second target audio in different audio segments according to each piece of the feature similarity.

In some optional implementations, the feature similarity determining unit includes:
a time acquiring sub-unit, configured to acquire a duration corresponding to each audio segment;
a number-of-hits determining sub-unit, configured to determine, based on the first audio fingerprint and the second audio fingerprint, a number of feature hits of different audio segments to be compared at a start time; and
a similarity determining sub-unit, configured to determine the feature similarity between the different audio segments according to the number of feature hits and the duration.

In some optional implementations, the audio similarity determining unit includes:
a maximum similarity determining sub-unit, configured to compare the feature similarity between different audio segments and determine the maximum feature similarity between the different audio segments;
an averaging sub-unit, configured to average the pieces of maximum feature similarity to obtain target feature similarity between the different audio segments; and
a difference calculating sub-unit, configured to determine the audio similarity between the different audio segments based on a difference between the target feature similarity and 1.

In some optional implementations, the slicing module 402 includes:
a feature extracting unit, configured to extract a first feature corresponding to the first target audio and a second feature corresponding to the second target audio;
a first audio slicing unit, configured to slice the first target audio according to audio time information carried in the first feature to obtain a plurality of first audio segments corresponding to the first target audio; and
a second audio slicing unit, configured to slice the second target audio according to audio time information carried in the second feature to obtain a plurality of second audio segments corresponding to the second target audio.

In some optional implementations, the feature extracting unit includes:
a peak extracting sub-unit, configured to acquire a frequency spectrum corresponding to the first target audio and extract peak point features from the frequency spectrum;
a constellation generating sub-unit, configured to combine peak point features in a target region to generate a constellation feature corresponding to the target audio; and
an encoding sub-unit, configured to perform encoding processing on the constellation feature to obtain the first feature.

In some optional implementations, the apparatus further includes:
an information-to-be-aggregated acquiring module, configured to acquire a target audio set to be aggregated;
a same segment determining module, configured to determine, for any audio segment in the target audio set, a same audio segment in the target audio set according to the audio similarity; and
an aggregating module, configured to perform aggregation processing on the same audio segments to generate an audio aggregation result.

Further functional descriptions of the above modules and units are the same as the corresponding embodiments above, and will not be repeated here.

The apparatus for determining a same audio in this embodiment is presented in the form of a functional unit, and the unit herein refers to an ASIC (Application Specific Integrated Circuit) circuit, a processor and a memory that execute one or more pieces of software or fixed programs, and/or other devices that may provide the above functions.

According to the apparatus for determining a same audio provided in this embodiment, before determining audio similarity, the first target audio and the second target audio to be compared are sliced to obtain corresponding audio segments; the audio fingerprint corresponding to each audio segment is generated, and the audio segments are compared based on the audio fingerprint of each audio segment, so as to determine the audio similarity between the first target audio and the second target audio in different audio segments, thereby effectively identifying the same audio segments in the first target audio and the second target audio, facilitating accurate recall for audios such as medleys, repeated melodies, and white noise, improving discrimination accuracy of the same audio segment, reducing mismatch of the same audio segment, and thus improving robustness to locally different audios.

An embodiment of the present disclosure further provides a computer device having the apparatus for determining a same audio shown in FIG. 4 above.

Please refer to FIG. 5. FIG. 5 is a schematic structural diagram of a computer device provided by an optional embodiment of the present disclosure. As shown in FIG. 5, the computer device includes: one or more processors 10, a memory 20, and interfaces for connecting various components, including high-speed interfaces and low-speed interfaces. The components communicate with each other using different buses and may be installed on a common main board or in other ways as needed. The processor may process instructions executed within the computer device, including instructions stored in or on the memory to display graphical information of GUI on an external input/output apparatus (such as a display device coupled to the interface). In some optional implementations, if required, multiple processors and/or multiple buses may be used with multiple memories. Similarly, multiple computer devices may be connected, and each device provides some necessary operations (for example, as a server array, a group of blade servers, or a multi-processor system). In FIG. 5, one processor 10 is taken as an example.

The processor 10 may be a central processing unit, a network processor, or a combination thereof. The processor 10 may further include a hardware chip. The hardware chip may be an application specific integrated circuit, a programmable logic device, or a combination thereof. The programmable logic device may be a complex programmable logic device, a field programmable logic gate array, a generic array logic, or any combination thereof.

The memory 20 stores instructions executable by at least one processor 10, so that the at least one processor 10 executes the method shown in the above embodiments.

The memory 20 may include a program storage area and a data storage area, where the program storage area may store an operating system and an application program required by at least one function; the data storage area may store data created according to the use of the computer device, etc. In addition, the memory 20 may include a high-speed random access memory or a non-transitory memory, such as at least one magnetic disk storage device, a flash memory device, or other non-transitory solid-state storage devices. In some optional implementations, the memory 20 optionally includes memories remotely provided with respect to the processor 10, and these remote memories may be connected to the computer device through a network. Examples of the above network include but not limited to Internet, an intranet, a local area network, a mobile communication network, and a combination thereof.

The memory 20 may include a volatile memory, such as a random access memory; the memory may also include a non-volatile memory, such as a flash memory, a hard disk or a solid state disk; the memory 20 may further include a combination of the above kinds of memories.

The computer device further includes an input apparatus 30 and an output apparatus 40. The processor 10, the memory 20, the input apparatus 30, and the output apparatus 40 may be connected through a bus or in other ways. In FIG. 5, connection through a bus is used as an example.

The input apparatus 30 may receive input digital or character information, and generate a key signal input related to user settings and function control of the computer device, such as a touch screen, a keypad, a mouse, a track pad, a touch panel, an indicator pole, one or more mouse buttons, a trackball, a joystick, etc. The output apparatus 40 may include a display device, an auxiliary lighting apparatus (such as an LED), a tactile feedback apparatus (such as a vibration motor), etc. The above display device includes but not limited to a liquid crystal display, a light emitting diode, a display, and a plasma display. In some optional implementations, the display device may be a touch screen.

The computer device further includes a communication interface for the computer device to communicate with other devices or communication networks.

An embodiment of the present disclosure further provides a computer-readable storage medium. The method according to the embodiments of the present disclosure may be implemented in hardware and firmware, or implemented as computer codes that are downloaded through a network and originally stored in a remote storage medium or a non-transitory machine-readable storage medium and will be stored in a local storage medium. Thus, the methods described here may be processed by such software stored on the storage medium of a general-purpose computer, a special-purpose processor, or programmable or special-purpose hardware. The storage medium may be a magnetic disk, an optical disk, a read-only memory, a random access memory, a flash memory, a hard disk or a solid state disk, etc. Further, the storage medium may also include a combination of the above kinds of memories. It may be understood that the computer, the processor, the microprocessor controller or the programmable hardware includes a storage component that may store or receive software or computer code, and when the software or computer codes are accessed and executed by the computer, the processor or the hardware, the method shown in the above embodiments is implemented.

A part of the present disclosure may be applied as a computer program product, such as computer program instructions, which, when executed by a computer, may invoke or provide the method and/or technical solution according to the present disclosure through the operation of the computer. Those skilled in the art should understand that the forms of computer program instructions exist in a computer-readable medium including but not limited to a source file, an executable file, an installation package file, etc. Accordingly, the methods of the computer program instructions are executed by the computer including but not limited to: the computer directly executes the instructions, or the computer compiles the instructions and then executes the corresponding compiled program, or the computer reads and executes the instructions, or the computer reads and installs the instructions and then executes the corresponding installed program. Here, the computer-readable medium may be any available computer-readable storage medium or communication medium accessible by the computer.

Although the embodiments of the present disclosure are described in combination with the drawings, those skilled in the art may make various modifications and variations without departing from the spirit and scope of the present disclosure, and such modifications and variations fall within the scope defined by the appended claims.

1. A method for determining a same audio, comprising:
acquiring a first target audio and a second target audio to be compared;
performing slicing processing on the first target audio and the second target audio to obtain a plurality of first audio segments corresponding to the first target audio and a plurality of second audio segments corresponding to the second target audio;
generating a first audio fingerprint corresponding to each first audio segment based on audio features of the first audio segment, and generating a second audio fingerprint corresponding to each second audio segment based on audio features of the second audio segment; and
determining audio similarity between the first target audio and the second target audio in different audio segments according to the first audio fingerprint and the second audio fingerprint.

2. The method of claim 1, wherein the determining the audio similarity between the first target audio and the second target audio in the different audio segments according to the first audio fingerprint and the second audio fingerprint comprises:
determining feature similarity between the first target audio and the second target audio in different audio segments based on the first audio fingerprint and the second audio fingerprint; and
determining the audio similarity between the first target audio and the second target audio in different audio segments according to each piece of the feature similarity.

3. The method of claim 2, wherein the determining the audio similarity between the first target audio and the second target audio in the different audio segments according to each piece of the feature similarity comprises:
comparing the feature similarity between different audio segments, and determining maximum feature similarity between the different audio segments;
averaging pieces of the maximum feature similarity to obtain target feature similarity between the different audio segments; and
determining the audio similarity between the different audio segments based on a difference between the target feature similarity and 1.

4. The method of claim 2, wherein the determining the feature similarity between the first target audio and the second target audio in the different audio segments based on the first audio fingerprint and the second audio fingerprint comprises:
acquiring a duration corresponding to each audio segment;
determining a number of feature hits at a start time of the different audio segments to be compared based on the first audio fingerprint and the second audio fingerprint; and
determining the feature similarity between the different audio segments according to the number of feature hits and the duration.

5. The method of claim 1, wherein the performing the slicing processing on the first target audio and the second target audio to obtain the plurality of first audio segments corresponding to the first target audio and the plurality of second audio segments corresponding to the second target audio comprises:
extracting a first feature corresponding to the first target audio and a second feature corresponding to the second target audio;
slicing the first target audio according to audio time information carried in the first feature to obtain a plurality of first audio segments corresponding to the first target audio; and
slicing the second target audio according to audio time information carried in the second feature to obtain a plurality of second audio segments corresponding to the second target audio.

6. The method of claim 5, wherein the extracting the first feature corresponding to the first target audio comprises:
acquiring a frequency spectrum corresponding to the first target audio, and extracting peak point features from the frequency spectrum;
combining the peak point features in a target region to generate a constellation feature corresponding to the target audio; and
performing encoding processing on the constellation feature to obtain the first feature.

7. The method of claim 1, further comprising:
acquiring a target audio set to be aggregated;
determining, for any audio segment in the target audio set, same audio segments in the target audio set according to the audio similarity; and
performing aggregation processing on the same audio segments to generate an audio aggregation result.

8. A computer device, comprising:
a memory and a processor, wherein the memory and the processor are communicatively connected to each other, the memory stores computer instructions, and the processor executes the computer instructions to perform a method for determining a same audio, comprising:
acquiring a first target audio and a second target audio to be compared;
performing slicing processing on the first target audio and the second target audio to obtain a plurality of first audio segments corresponding to the first target audio and a plurality of second audio segments corresponding to the second target audio;
generating a first audio fingerprint corresponding to each first audio segment based on audio features of the first audio segment, and generating a second audio fingerprint corresponding to each second audio segment based on audio features of the second audio segment; and
determining audio similarity between the first target audio and the second target audio in different audio segments according to the first audio fingerprint and the second audio fingerprint.

9. The computer device of claim 8, wherein the determining the audio similarity between the first target audio and the second target audio in the different audio segments according to the first audio fingerprint and the second audio fingerprint comprises:
determining feature similarity between the first target audio and the second target audio in different audio segments based on the first audio fingerprint and the second audio fingerprint; and
determining the audio similarity between the first target audio and the second target audio in different audio segments according to each piece of the feature similarity.

10. The computer device of claim 9, wherein the determining the audio similarity between the first target audio and the second target audio in the different audio segments according to each piece of the feature similarity comprises:
comparing the feature similarity between different audio segments, and determining maximum feature similarity between the different audio segments;
averaging pieces of the maximum feature similarity to obtain target feature similarity between the different audio segments; and
determining the audio similarity between the different audio segments based on a difference between the target feature similarity and 1.

11. The computer device of claim 9, wherein the determining the feature similarity between the first target audio and the second target audio in the different audio segments based on the first audio fingerprint and the second audio fingerprint comprises:
acquiring a duration corresponding to each audio segment;
determining a number of feature hits at a start time of the different audio segments to be compared based on the first audio fingerprint and the second audio fingerprint; and
determining the feature similarity between the different audio segments according to the number of feature hits and the duration.

12. The computer device of claim 8, wherein the performing the slicing processing on the first target audio and the second target audio to obtain the plurality of first audio segments corresponding to the first target audio and the plurality of second audio segments corresponding to the second target audio comprises:
extracting a first feature corresponding to the first target audio and a second feature corresponding to the second target audio;
slicing the first target audio according to audio time information carried in the first feature to obtain a plurality of first audio segments corresponding to the first target audio; and
slicing the second target audio according to audio time information carried in the second feature to obtain a plurality of second audio segments corresponding to the second target audio.

13. The computer device of claim 12, wherein the extracting the first feature corresponding to the first target audio comprises:
acquiring a frequency spectrum corresponding to the first target audio, and extracting peak point features from the frequency spectrum;
combining the peak point features in a target region to generate a constellation feature corresponding to the target audio; and
performing encoding processing on the constellation feature to obtain the first feature.

14. The computer device of claim 8, further comprising:
acquiring a target audio set to be aggregated;
determining, for any audio segment in the target audio set, same audio segments in the target audio set according to the audio similarity; and
performing aggregation processing on the same audio segments to generate an audio aggregation result.

15. A non-transitory computer-readable storage medium, wherein the computer-readable storage medium stores computer instructions, and the computer instructions are configured to cause a computer to perform a method for determining a same audio, comprising:
acquiring a first target audio and a second target audio to be compared;
performing slicing processing on the first target audio and the second target audio to obtain a plurality of first audio segments corresponding to the first target audio and a plurality of second audio segments corresponding to the second target audio;
generating a first audio fingerprint corresponding to each first audio segment based on audio features of the first audio segment, and generating a second audio fingerprint corresponding to each second audio segment based on audio features of the second audio segment; and
determining audio similarity between the first target audio and the second target audio in different audio segments according to the first audio fingerprint and the second audio fingerprint.

16. The non-transitory computer-readable storage medium of claim 15, wherein the determining the audio similarity between the first target audio and the second target audio in the different audio segments according to the first audio fingerprint and the second audio fingerprint comprises:
determining feature similarity between the first target audio and the second target audio in different audio segments based on the first audio fingerprint and the second audio fingerprint; and
determining the audio similarity between the first target audio and the second target audio in different audio segments according to each piece of the feature similarity.

17. The non-transitory computer-readable storage medium of claim 16, wherein the determining the audio similarity between the first target audio and the second target audio in the different audio segments according to each piece of the feature similarity comprises:
comparing the feature similarity between different audio segments, and determining maximum feature similarity between the different audio segments;
averaging pieces of the maximum feature similarity to obtain target feature similarity between the different audio segments; and
determining the audio similarity between the different audio segments based on a difference between the target feature similarity and 1.

18. The non-transitory computer-readable storage medium of claim 16, wherein the determining the feature similarity between the first target audio and the second target audio in the different audio segments based on the first audio fingerprint and the second audio fingerprint comprises:
acquiring a duration corresponding to each audio segment;
determining a number of feature hits at a start time of the different audio segments to be compared based on the first audio fingerprint and the second audio fingerprint; and
determining the feature similarity between the different audio segments according to the number of feature hits and the duration.

19. The non-transitory computer-readable storage medium of claim 15, wherein the performing the slicing processing on the first target audio and the second target audio to obtain the plurality of first audio segments corresponding to the first target audio and the plurality of second audio segments corresponding to the second target audio comprises:
extracting a first feature corresponding to the first target audio and a second feature corresponding to the second target audio;
slicing the first target audio according to audio time information carried in the first feature to obtain a plurality of first audio segments corresponding to the first target audio; and
slicing the second target audio according to audio time information carried in the second feature to obtain a plurality of second audio segments corresponding to the second target audio.

20. The non-transitory computer-readable storage medium of claim 19, wherein the extracting the first feature corresponding to the first target audio comprises:
acquiring a frequency spectrum corresponding to the first target audio, and extracting peak point features from the frequency spectrum;
combining the peak point features in a target region to generate a constellation feature corresponding to the target audio; and
performing encoding processing on the constellation feature to obtain the first feature.
